(19) United States
(12) Patent Application Publication
(10) Pub. No.: US 2015/0177276 A1
(43) Pub. Date: Jun. 25, 2015

(54) Scanning Probe Miscroscope

(71) Applicant: Hitachi, Ltd., Chiyoda-ku, Tokyo (JP)

(72) Inventors: Takehiro Tachizaki, Tokyo (JP); Toshihiko Nakata, Tokyo (JP); Masahiro Watanabe, Tokyo (JP)

(21) Appl. No.: 14/411,731

(22) PCT Filed: May 27, 2013
(86) PCT No.: PCT/JP2013/064569

§ 371 Date: Dec. 29, 2014

(30) Foreign Application Priority Data
Jul. 4, 2012 (JP) 2012-150066

(51) Int. Cl. G01Q 60/18

(52) U.S. Cl. CPC G01Q 60/18

(57) ABSTRACT

A scanning probe microscope includes a support member, a light source, and a near-field light detection sensor. The support member supports a probe. The light source causes excitation light to enter the support member. The near-field light detection sensor detects near-field light which is generated at a top of the probe by plasmon excited by the excitation light entering the support member and which is scattered from a surface of a measurement object. A microstructure that guides the excitation light to an excitation point of the plasmon is provided at a portion, which is irradiated with the excitation light, of the support member.

### TECHNICAL FIELD

The present invention relates to a scanning probe microscope.

### BACKGROUND ART

A scanning probe microscope (SPM) is known as a technique of measurement of a microscopic region. Among the scanning probe microscopes, an atomic force microscope (AFM) is widely used as a technique that scans a sample surface with a precisely controlled probe with a sharpened apex and can measure an atomic size nanostructure (PTL 1). However, the atomic force microscope cannot measure optical properties such as a refractive index distribution of a sample surface.

On the other hand, in a state-of-the-art nanostructure semiconductor device, its performance is improved by controlling physical properties in nanometer order and it is required to measure physical properties in nanometer order other than the shape. In a storage device or the like, a minute foreign particle causes a critical failure of a device operation, so that detailed analysis of physical properties of the foreign particle is required.

An optical spectroscopic measurement is suitable for measuring physical properties. For example, a Raman microscope in which Raman spectroscopy is performed under an optical microscope has been developed so far and is widely used for analysis. However, a spatial resolution of conventional optical microscope technique is several hundreds nm, which is insufficient for performing measurement in nanometer order, so that it is not possible to observe the details of the foreign particle.

As a means for solving these problems and measuring physical property information and optical properties of a sample surface in a high spatial resolution, there is a near-field scanning optical microscope (NSOM).

As described in NPL 2, the near-field scanning optical microscope uses near-field light leaked from a minute aperture of about several tens nm, for example, in a means called an aperture probe method. It is possible to measure the optical properties of the sample surface with a spatial resolution of several tens nm which is approximately the same as the size of the aperture by scanning the aperture while maintaining a gap between the minute aperture and the sample in a range from several nm to several tens nm.

Further, NPL 3 discloses a near-field scanning optical microscope that realizes an optical observation with a spatial resolution of several tens nm by irradiating a sharpened probe tip with light and using near-field light generated at the probe tip depending on an interaction with the sample and scattered light of the near-field light. This method is known as a scattering probe method.

The aperture probe method and the scattering probe method have a problem that it is difficult to perform high accuracy and high sensitivity measurement because the light leaked from the minute aperture is weak or the interaction with the sample is weak and detected light is weak.

To solve these problems, a plasmon light guide method is proposed, which guides light to a probe tip by using plasmon by using a carbon nanotube (hereinafter referred to as CNT as needed) as described in PTL 1 or PTL 2. In the plasmon light guide method, as described in PTL 2 or PTL 3, a method is proposed, which irradiates a tip that fixes the CNT with light to excite plasmon and causes the plasmon to propagate to the CNT. This light guide method has advantages to be simple and highly efficient.

### CITATION LIST

### Patent Literature

PTL 1: JP 2008-256672 A
PTL 2: JP 2009-236895 A
PTL 3: JP 2010-197208 A

### Non Patent Literature

NPL 1: Physical Review Letters, vol. 56, No. 9, p. 930.
NPL 2: Chemical Reviews, 1999, vol. 99, No. 10, pp. 2891-2927.
NPL 3: Optics Letters, vol. 19, no. 3, p. 159.

### SUMMARY OF INVENTION

### Technical Problem

A near-field scanning optical microscope of the plasmon light guide method described in PTLs 1 to 3 uses a tip that fixes CNT and excites plasmon and a cantilever that supports the tip. The tip and the cantilever are often made of silicon, so that they are opaque in a visible light band. Therefore, near infrared light is used as excitation light that excites the plasmon, so that there is a problem that it is not possible to visually confirm a position to be irradiated with the excitation light.

The excitation of the plasmon is very sensitive to an irradiation position and an irradiation angle of the excitation light. Therefore, when an optimal excitation condition is not obtained, there is a problem that the plasmon cannot be excited and thereby the near-field light at a CNT probe is weak and a signal is weak or light which does not engage with the excitation of plasmon and which directly leaks from the tip increases and thereby background light and noise increase.

On the other hand, it is very difficult to manufacture a tip and a cantilever which have a shape and a size preferable for fixing the CNT and exciting the plasmon with a transparent material.

In view of the above problems, an object of the present invention is to provide a scanning probe microscope which improves the excitation efficiency of the plasmon and consequently improves the excitation efficiency of the near-field light.

### Solution to Problem

To solve the above problem, the present invention provides a scanning probe microscope, including: a support member that supports a probe; a light source that causes excitation light to enter the support member; and a near-field light detection sensor that detects near-field light which is generated at a top of the probe by plasmon excited by the excitation light entering the support member and which is scattered from a surface of the measurement object, wherein a microstructure that guides the excitation light to an excitation point of the plasmon is provided at a portion, which is irradiated with the excitation light, of the support member.

The present invention from another viewpoint provides a scanning probe microscope including a support member that supports a probe, a light source that causes excitation light to enter the support member, and a near-field light detection sensor that detects near-field light which is generated at a top of the probe by plasmon excited by the excitation light entering the support member and which is scattered from a surface of a measurement object, wherein an optical frequency conversion element that converts an optical frequency of the excitation light is provided to the support member.

### Advantageous Effects of Invention

According to the present invention, it is possible to provide a scanning probe microscope in which the excitation efficiency of the near-field light is improved by improving excitation conditions of the plasmon.

### BRIEF DESCRIPTION OF DRAWINGS

FIG. 1 is a diagram illustrating a cantilever structure having a refractive surface according to a first embodiment of the present invention.

FIG. 2 is a diagram illustrating a specific structure of a cantilever having a refractive surface according to the first embodiment of the present invention.

FIG. 3 is a diagram for explaining a definition of an angle of an inclined cantilever according to the first embodiment of the present invention.

FIG. 4 is an illustration of a method of indirectly fabricating a refractive surface by FIB (Focused Ion Beam) according to the first embodiment of the present invention.

FIG. 5 is an illustration of a method of directly fabricating a refractive surface by FIB (Focused Ion Beam) according to the first embodiment of the present invention.

FIG. 6 is a conceptual diagram of forming a cantilever by a deposition method according to the first embodiment of the present invention.

FIG. 7 is an illustration of a forming method of a refractive surface by a deposition method using a mold according to the first embodiment of the present invention.

FIG. 8 is an illustration of a method of newly forming a refractive surface by a deposition method according to the first embodiment of the present invention.

FIG. 9 is a conceptual diagram of a cantilever having a diffractive surface that diffracts light according to the first embodiment of the present invention.

FIG. 10 is a diagram illustrating a diffractive surface that diffracts light according to the first embodiment of the present invention.

FIG. 11 is a diagram illustrating a principle that the diffractive surface diffracts light according to the first embodiment of the present invention.

FIG. 12 is a diagram illustrating a microstructure that diffracts light and collects light according to the first embodiment of the present invention.

FIG. 13 is an illustration of a cantilever structure including a curved refractive surface that collects light by refraction according to the first embodiment of the present invention.

FIG. 14 is an illustration of a principle of collecting light by refraction according to the first embodiment of the present invention.

FIG. 15 is an illustration of a tip having a structure that converts a wavelength according to a second embodiment of the present invention.

FIG. 16 is an illustration of a tip including a cantilever having a refractive surface and a structure that converts a wavelength according to a third embodiment of the present invention.

FIG. 17 is an illustration of a tip including a cantilever having a curved refractive surface and a structure that converts a wavelength according to the third embodiment of the present invention.

FIG. 18 is a diagram illustrating a scanning probe microscope according to the first embodiment of the present invention.

### DESCRIPTION OF EMBODIMENTS

### First Embodiment

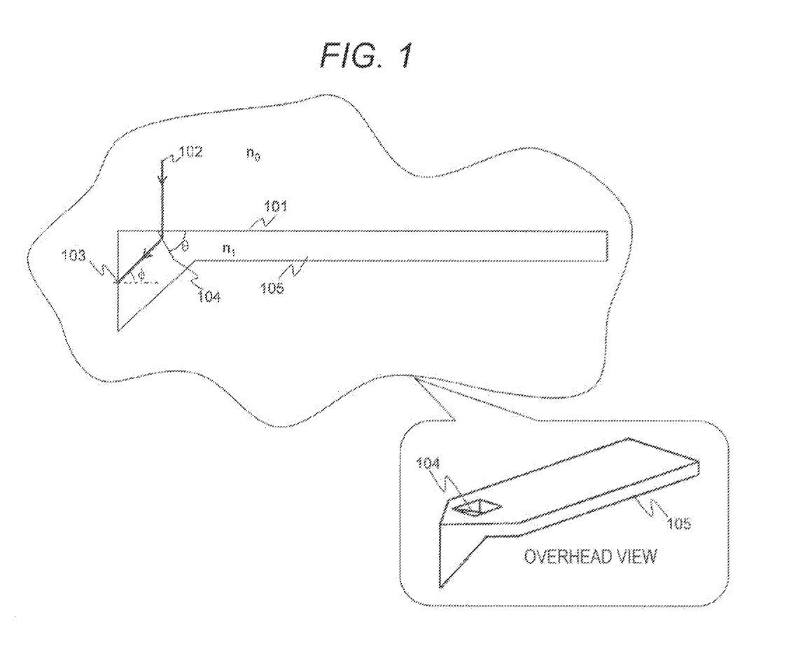

A first embodiment of the present invention will be described with reference to FIGS. 1 to 14 and 18.

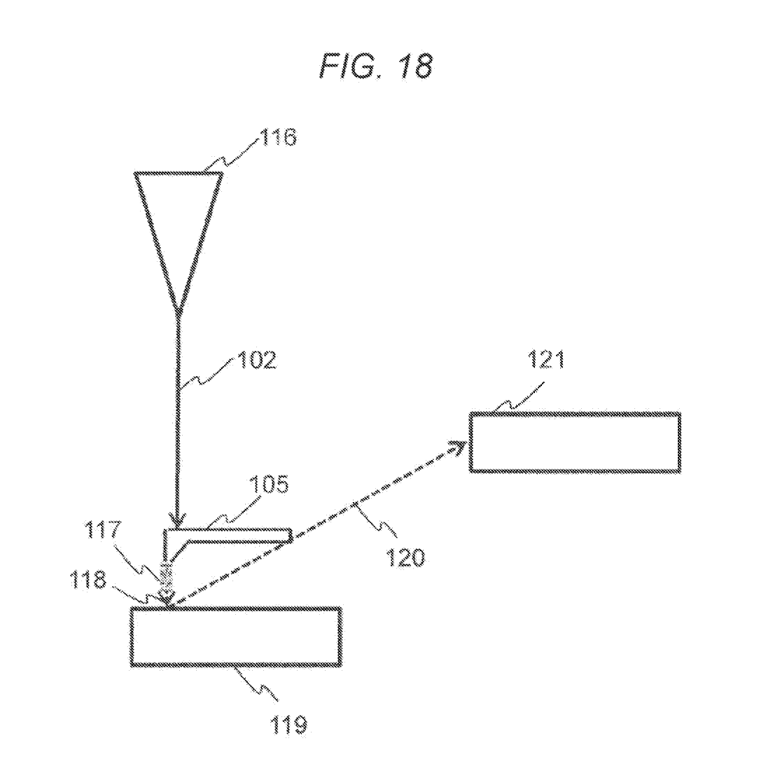

FIG. 18 illustrates a scanning probe microscope according to the present embodiment. In the present embodiment, a light source 116 irradiates a cantilever 105 that is a support member supporting a probe 117 (measurement probe) with excitation light 102. The excitation light is, for example, a laser beam irradiated from the light source 116. When the cantilever 105 is irradiated with the laser beam, plasmon is excited and the plasmon propagates from the cantilever 105 to the probe 117. The plasmon that propagates from the cantilever 105 to the probe 117 propagates to the top of the probe 117 and near-field light 118 is generated at the top of the probe 117. The near-field light 118 generated at the top of the probe 117 is scattered (reflected) on a surface of a sample 119 to be scattered light 120 and detected by a near-field light detection sensor 121. It is possible to scan the surface of the sample 119 by the probe 117 and measure optical properties of the surface of the sample 119 by changing relative positions between the cantilever 105 coupled with the probe 117 and the sample 119 by a drive mechanism.

In each embodiment of the present invention, a tip may be provided on the surface of the cantilever 105 and the tip may be irradiated with the excitation light. In this case, the cantilever 105 including the tip is referred to as a support member.

In the present embodiment, a cantilever having a structure for causing incident excitation light to enter a point where the plasmon is excited at a predetermined angle in order to excite the plasmon with high efficiency will be described.

FIG. 1 illustrates an example of a structure of the cantilever 105. This is a microfabricated cantilever 105 provided with a refractive surface 104 used as a microstructure that refracts the excitation light 102 irradiated to a rear surface 101 of the cantilever 105 (a surface through which the excitation light that excites the plasmon is caused to enter the cantilever 105) so that the excitation light 102 enters a plasmon excitation point 103 at a predetermined angle (an overhead view of the microfabricated cantilever 105 is illustrated in the lower right of FIG. 1).

In FIG. 1, it is assumed that the excitation light 102 vertically enters the cantilever rear surface 101 from above the microfabricated cantilever 105, an optimal plasmon incident angle at the plasmon excitation point 103 is Φ, and an angle formed by the refractive surface 104 with the cantilever rear surface 101 is θ. When a refractive index of an environment around the microfabricated cantilever 105 is n0 and a refractive index at a wavelength of the excitation light 102 of a material forming the cantilever 105 is n1, a traveling direction A of the excitation light 102 after refraction is represented as Expression 1 in vector expression. Here, regarding coordinates, an XY coordinate system illustrated in FIG. 1 is employed.

$$A = ( \begin{matrix}( \frac{{n}_{0}}{{n}_{1}} - 1 ) sin θcos θ \\ - \frac{{n}_{0}}{{n}_{1}} {( sin θ )}^{2} - {( cos θ )}^{2}\end{matrix} ) \qquad [ Mathematical Formula 1 ]$$

When the vector A illustrated in Expression 1 indicates the same direction as that of a vector B represented by Expression 2, efficient plasmon excitation is possible at the excitation point 103.

$$B = ( \begin{matrix}- cos Φ \\ - sin Φ\end{matrix} ) \qquad [ Mathematical Formula 2 ]$$

As a result, when a necessary incident angle Φ is determined, the angle θ formed between the refractive surface 104 and the cantilever rear surface 101 is uniquely determined by solving Expression 3 for θ. In Expression 3, C is a factor to equalize the sizes of the left and right vectors. In practice, it is assumed that a method of determining θ by equalizing a ratio of the left-hand side of Expression 3 and a ratio of the right-hand side of Expression 3 is simple.

$$C ( \begin{matrix}- cos Φ \\ - sin Φ\end{matrix} ) = ( \begin{matrix}( \frac{{n}_{0}}{{n}_{1}} - 1 ) sin θ cos θ \\ - \frac{{n}_{0}}{{n}_{1}} {( sin θ )}^{2} - {( cos θ )}^{2}\end{matrix} ) \qquad [ Mathematical Formula 3 ]$$

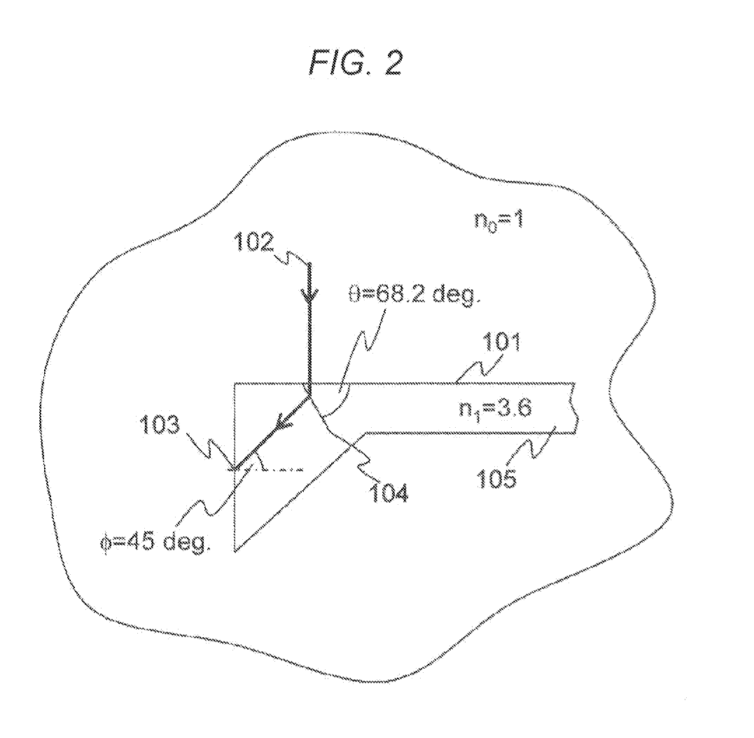

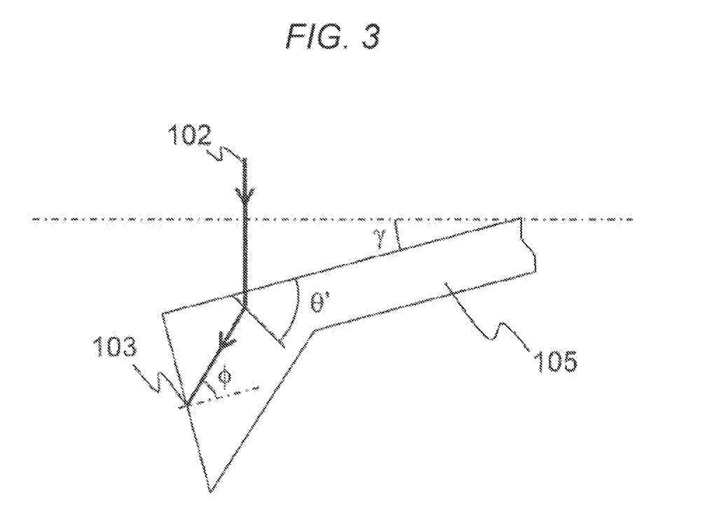

FIG. 2 illustrates a light beam of the excitation light 102 that passes through the refractive surface 104 at the angle θ determined in this way. In FIG. 2, the excitation light 102 vertically enters the cantilever rear surface 101. However, an actual entering direction is not limited to the vertical direction, but may be inclined by γ as illustrated in FIG. 3. In this case, the angle θ of the refractive surface 104 has to be corrected to θ−γ.

As an example, θ in the case of Φ=45° is determined by Expression 4.

$$tan θ = \frac{\frac{1}{2} \frac{{n}_{0}}{{n}_{1}} - \frac{1}{2} \pm \sqrt{{( \frac{{n}_{0}}{{n}_{1}} )}^{2} - \frac{3}{4} {( 1 - \frac{{n}_{0}}{{n}_{1}} )}^{2}}}{1 - 2 \frac{{n}_{0}}{{n}_{1}}} \qquad [ Mathematical Formula 4 ]$$

Although Expression 4 includes a double sign, Φ smaller than or equal to 90° can be uniquely determined. In this example, a positive sign is employed. For example, when the cantilever 105 is formed of silicon and is located in the atmosphere, n0 is 1 and n1 is 3.6, so that Φ is determined to be 68.2° (FIG. 2).

When the microfabricated cantilever 105 is designed so that the cantilever rear surface 101 and the refractive surface 104 maintain the angle θ calculated based on Expression 3 or Expression 4, it is possible to maintain the incident angle Φ of the excitation light 102 to the plasmon excitation point 103 at an optimal angle to excite the plasmon.

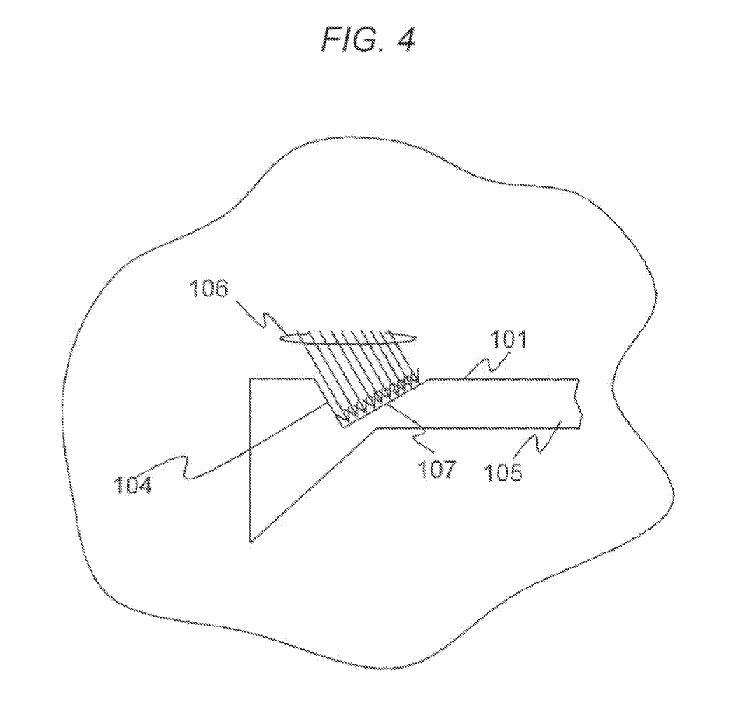

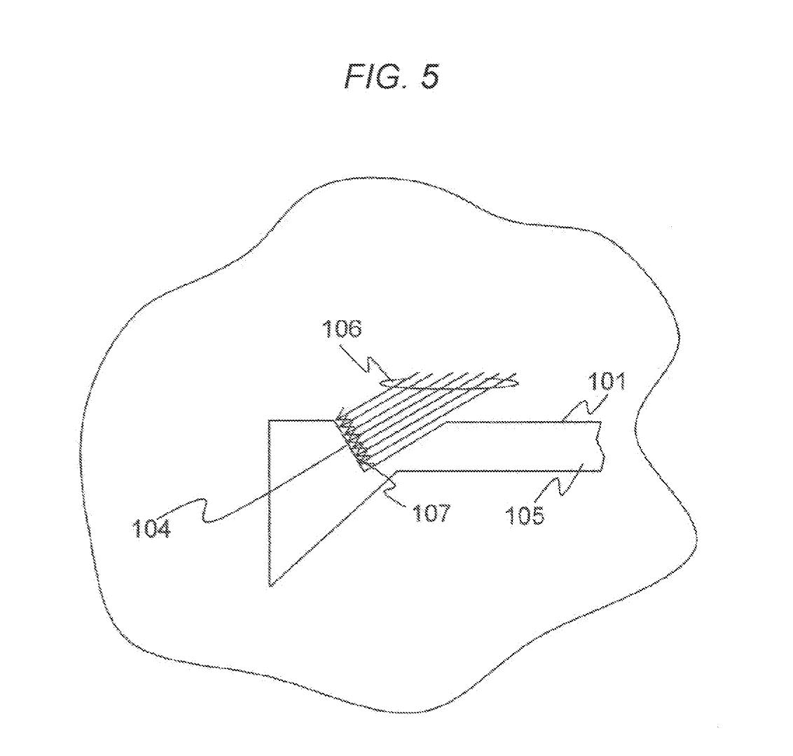

FIG. 4 illustrates an example of a fabricating method of the cantilever 105 including the refractive surface 104. The method illustrated in FIG. 4 is a method in which a focused ion beam 106 is irradiated in parallel with the refractive surface 104 to be formed and the cantilever is cut from the rear surface. The irradiation direction of the focused ion beam 106 as illustrated in FIG. 5 is also available. In the method illustrated in FIG. 4, even when the irradiation dose of the focused ion beam 106, that is, the amount of processing, varies to some extent, only some roughness occurs on a processed surface 107 and the quality of the refractive surface 104 is not affected, so that high processing accuracy is not required and the refractive surface 104 can be formed in a relatively simple manner.

On the other hand, in the method illustrated in FIG. 5, roughness occurs on the processed surface 107 unless the irradiation dose of the focused ion beam 106 is precisely controlled. In this case, the processed surface 107 is the refractive surface 104 itself, so that there is concern that a minute roughness refracts/diffracts the excitation light 102 at an angle other than a predetermined angle or scattered light occurs. Therefore, it is necessary to precisely control the focused ion beam 106.

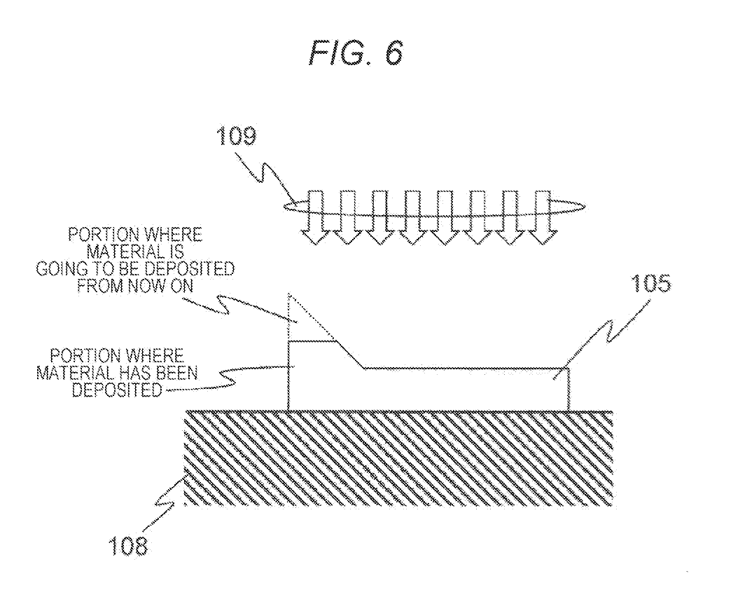

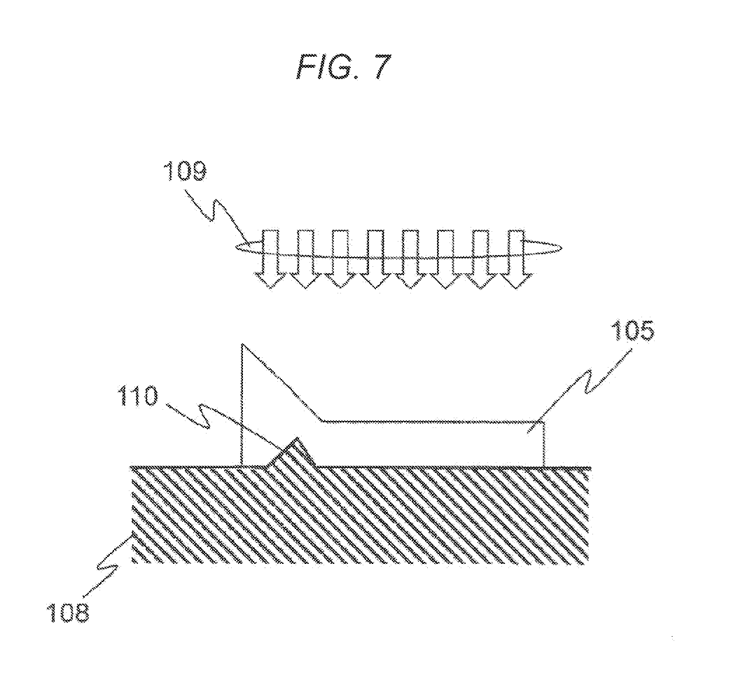

As other processing methods, for example, when the cantilever is formed of silicon having high crystallinity, it is possible to use anisotropic etching using crystal anisotropy of the silicon, and also it is possible to use a method using resist coating, exposure, and etching that are the same as those in a semiconductor manufacturing process and a MEMS (microelectromechanical system) manufacturing process. Alternatively, when the cantilever itself is fabricated by depositing a cantilever material 109 on a substrate 108 as illustrated in FIG. 6, it is possible to form the refractive surface 104 by transferring the minute mold structure 110 provided on the substrate 108 as illustrated in FIG. 7.

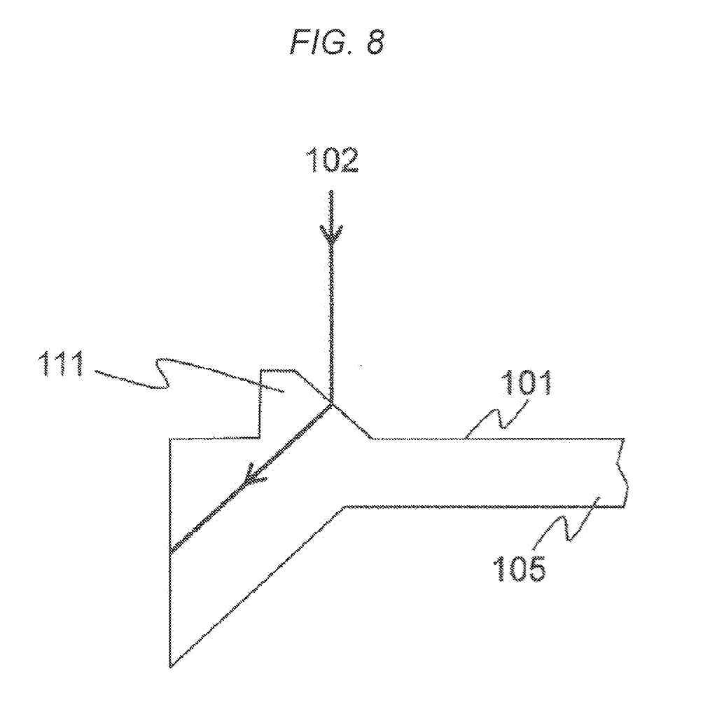

A method can be considered which newly provides a structure 111 on the cantilever rear surface 101 as illustrated in FIG. 8 instead of forming the refractive surface 104 by cutting the cantilever.

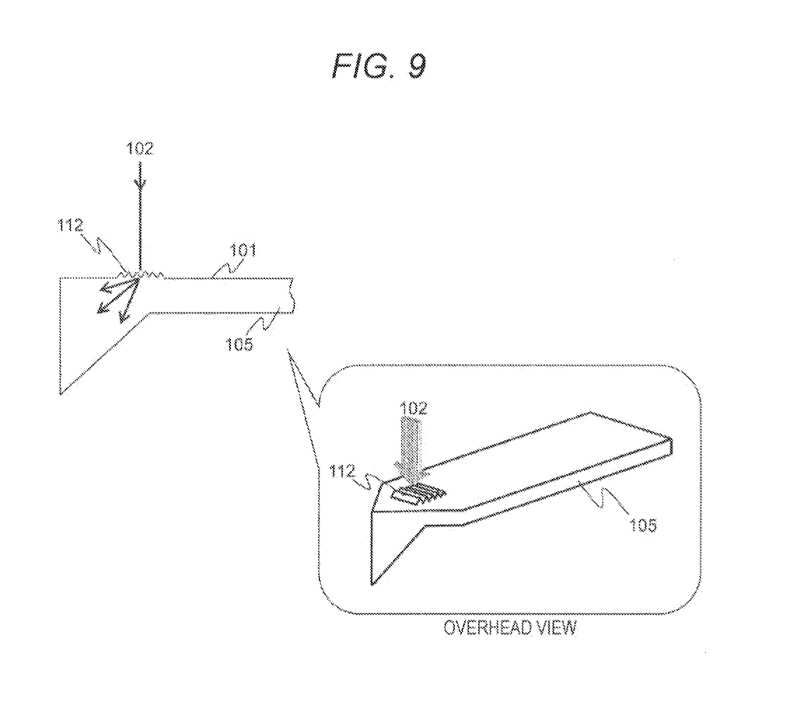

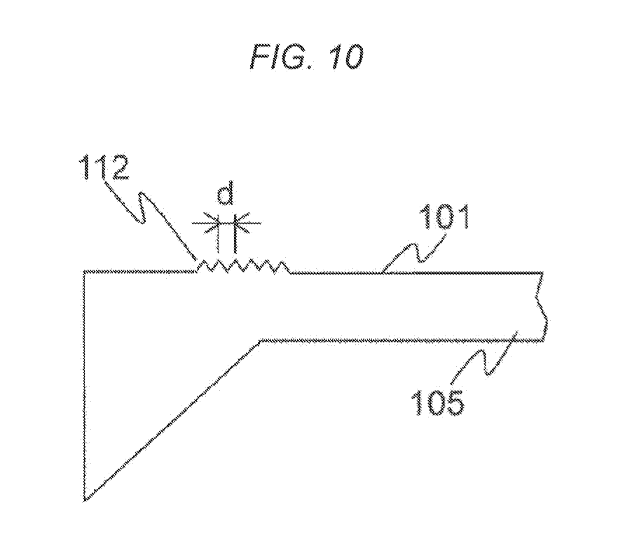

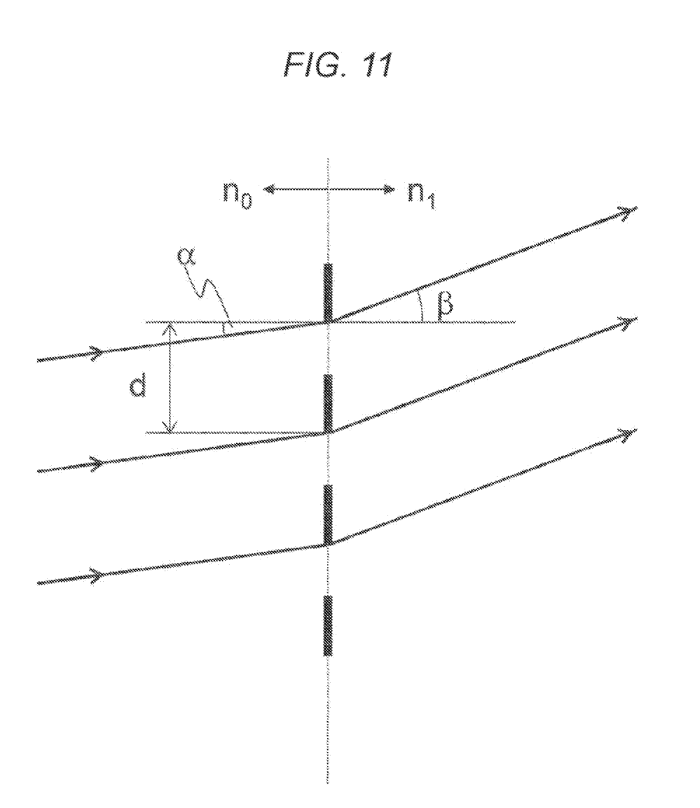

Besides the method of providing the refractive surface 104 on the cantilever rear surface 101, an embodiment illustrated in FIG. 9 can be considered. The embodiment illustrated in FIG. 9 is a method of guiding light to the excitation point 103 by providing a diffractive surface 112 as a microstructure on the cantilever rear surface 101 and diffracting the excitation light 102 entering the diffractive surface 112 (an overhead view of the microfabricated cantilever 105 is illustrated in the lower right of FIG. 9). As a specific example of the microstructure 112, for example, there is a transmission type diffraction grating as illustrated in FIG. 10. When the transmission type diffraction grating is used as illustrated in FIGS. 10 and 11, a wavelength λ and an incident angle α of the excitation light 102, a diffraction angle β, and a grating pitch d of the diffraction grating have a relationship illustrated in Expression 5.

$$d ( sin α + sin β ) = λ ( \frac{m}{{m}_{0}} + \frac{{m}^{′}}{{n}_{1}} ) \qquad [ Mathematical Formula 5 ]$$

Here, m and m′ are integers. When the incident angle α and the diffraction angle β, that is, an incident angle to the excitation point, is determined by Expression 5, the grating pitch d of the diffraction grating is determined and the design can be performed. Here, n is the diffraction order. For example, if it is assumed that m=1 and m′=1 are set by considering a diffraction angle of the lowest order, n0 is 1 and n1 is 3.6 when the fabricated cantilever 105 is formed of silicon and is located in the atmosphere, near infrared light of λ=800 nm is caused to vertically enter the cantilever rear surface 101 (α=0°), and an incident angle to the plasmon excitation point 103 is β=45°, the diffraction grating pitch d is 244 nm.

To fabricate a diffraction grating as the microstructure 112, for example, a method of focused ion beam processing, a method of nanoimprint, a method in which resist is coated on the cantilever rear surface 101 and etching is performed after a periodic pattern exposure, and a method in which a groove is cut by a tool such as a sharp needle harder than the material of the cantilever can be considered.

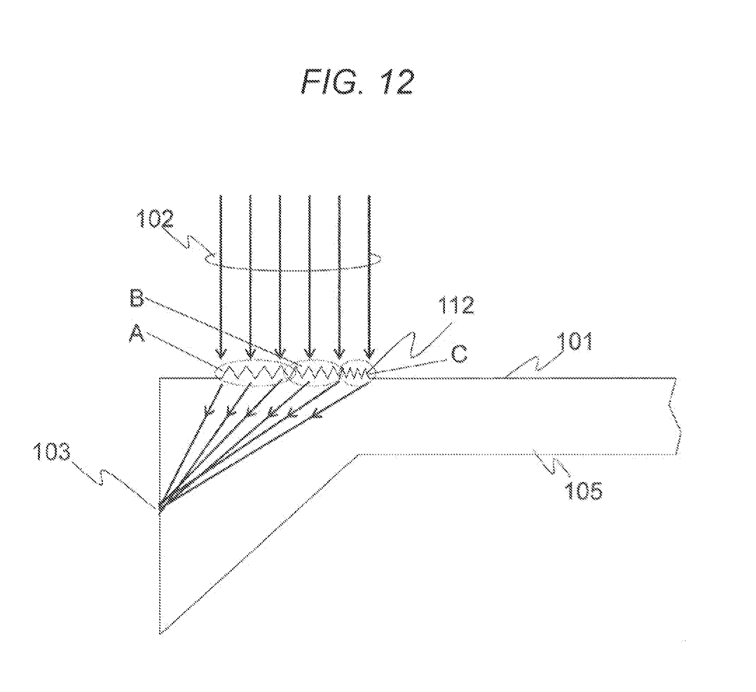

In FIGS. 9 and 10, the diffractive surface 112, which is a microstructure, changes the propagation direction of the excitation light 102. The diffractive surface 112 can also be designed so as to focus the light to the plasmon excitation point by forming the diffractive surface 112 by varying the pitch as illustrated in FIG. 12. This can be realized by performing the design by setting the grating pitch d determined according to Expression 5 to an area B around the center of the diffractive surface 112 illustrated in FIG. 12 so that the excitation light 102 enters at an aimed angle β, setting the diffraction grating pitch d greater than that in the area B to an area A so that the diffraction angle is small, and setting the grating pitch d smaller than that in the area B to an area C so that the diffraction angle is large.

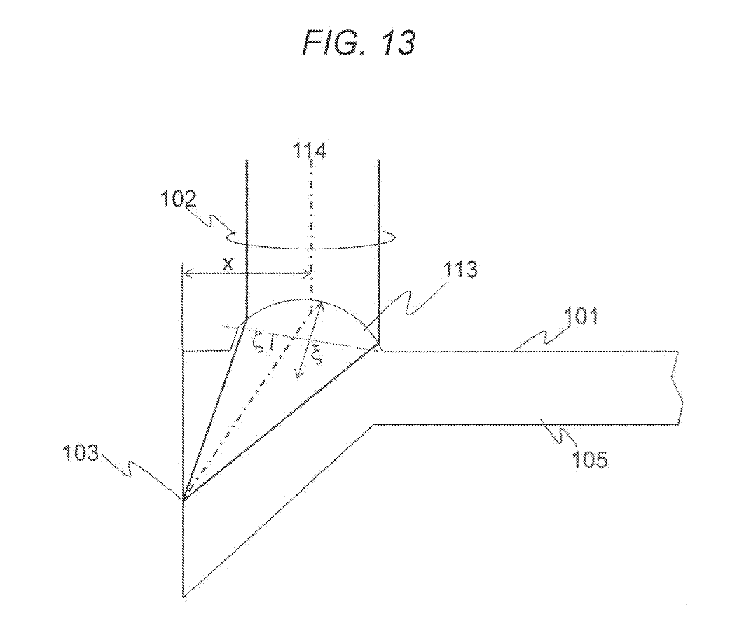

As a method of guiding the excitation light 102 to the excitation point 103, an embodiment illustrated in FIG. 13 can also be considered. FIG. 13 illustrates a method in which a curved refractive surface 113 is provided on the cantilever rear surface 101 as a microstructure.

The present embodiment is a method in which the excitation light 102 is refracted so that a light beam center 114 of the excitation light 102 enters the plasmon excitation point 103 at an angle where the plasmon can be efficiently excited and the excitation light 102 is focused. The method in which the curved refractive surface 113 is used has an advantage that the intensity of the excited plasmon can be increased because the intensity of the excitation light 102 at the plasmon excitation point can be increased as compared with a case in which the refractive surface 104 is used. On the other hand, to refract and focus the excitation light 102 by the curved refractive surface 113 without scattering the excitation light 102, the surface of the curved refractive surface 113 has to be smooth so that the roughness is reduced to be smaller than the wavelength of the excitation light 102. Regarding the processing, a means using a focused ion beam, a means using the same processing process as a semiconductor manufacturing process and a MEMS manufacturing process, a means of forming the curved refractive surface 113 by using a mold at the same time when fabricating the cantilever, a means of depositing a material having high affinity to a material that forms the cantilever on the cantilever rear surface 101 which is a flat surface, and the like can be considered.

A surface angel ζ of the curved refractive surface 113 is determined by Expression 3. On the other hand, a curvature radius ξ of the curve of the curved refractive surface 113 is determined by Expression 6.

$$ξ = f ( 1 - \frac{{n}_{0}}{{n}_{1}} ) \qquad [ Mathematical Formula 6 ]$$

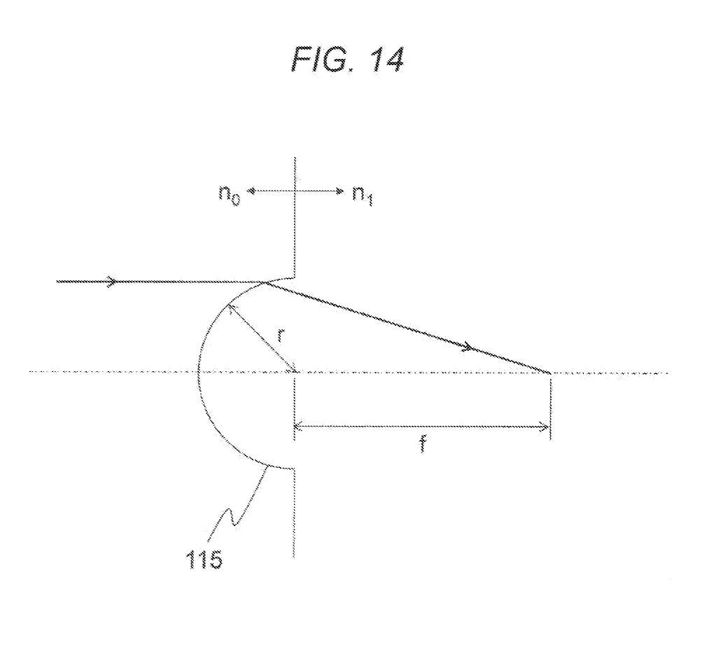

As illustrated in FIG. 14, Expression 6 is a formula representing a relationship between each physical quantity when a refractive index of a medium of the light incident side of a surface 115 having a curvature radius ξ is n0, a refractive index of a medium of the light emission side of the surface 115 (right side in FIG. 14) is n1, and light propagating from the left side of the surface 115 to the right side is focused to a position a distance f away from the apex 123 of the surface 115.

Thereby, when the center x of the curved refractive surface 113, that is, a position where the curved refractive surface 113 is provided, is determined, and the incident angle Φ to the excitation point 103 is determined, the curvature radius ξ is determined as Expression 7.

$$ξ = \frac{x}{sin Φ} ( 1 - \frac{{n}_{0}}{{n}_{1}} ) \qquad [ Mathematical Formula 7 ]$$

As described above, according to the present embodiment, a microstructure is provided on the cantilever rear surface so that the excitation light irradiated to the cantilever 105 accurately enters a position of a predetermined plasmon excitation point at a set optimal angle, so that it is possible to easily visually recognize the position where the excitation light should be irradiated. Further, the excitation light irradiated to the microstructure is refracted or diffracted, reflected, and focused by the microstructure described above, so that it is possible to accurately guide the excitation light at an optimal angle to the plasmon excitation point close to the probe where the plasmon can be efficiently excited. Thereby, it is possible to improve the excitation efficiency of the plasmon, and as a result, it is possible to improve the excitation efficiency of the near-field light. Further, the excitation efficiency of signal light, that is, the near-field light, is improved, so that it is possible to relatively reduce background light noise generated by the excitation light directly leaking from the cantilever and improve the signal to noise ratio (S/N) of the measurement result. Therefore, it is possible to realize more highly sensitive and highly accurate optical measurement of nanometer level.

Thereby, it is possible to perform, for example, an optical observation of nanostructure, a Raman spectrometric analysis of a minute region or a minute object of nanometer order, and a shape measurement using near-field light interference, which have not been realized. These measurement and observation are realized, so that it is possible to accurately perform physical property control and foreign particle analysis in manufacturing of a semiconductor device and a storage device. Therefore, it is possible to obtain useful effects such as improvement of device performance and reduction of waste due to improvement of yield in a manufacturing stage.

Further, optical properties can be measured, so that it will be possible to directly observe a minute living tissue, a bacteria, and a virus alive, and it is possible to realize a new microscopic analysis, such as measuring a shape and physical property of a molecule in nanometer order by directly observing the molecule, which has not been realized.

The high sensitivity contributes to the high-speed measurement. If behavior of living things can be directly observed by high-speed measurement, it leads to understanding of dynamics that occurs on a surface of a minute living tissue, a bacteria, and a virus (for example, movement of membrane protein and antigen-antibody reaction) and clarifying the function of these, and it is possible to observe a response in real time when administering medication and immediately determine the effect of the administration.

### Second Embodiment

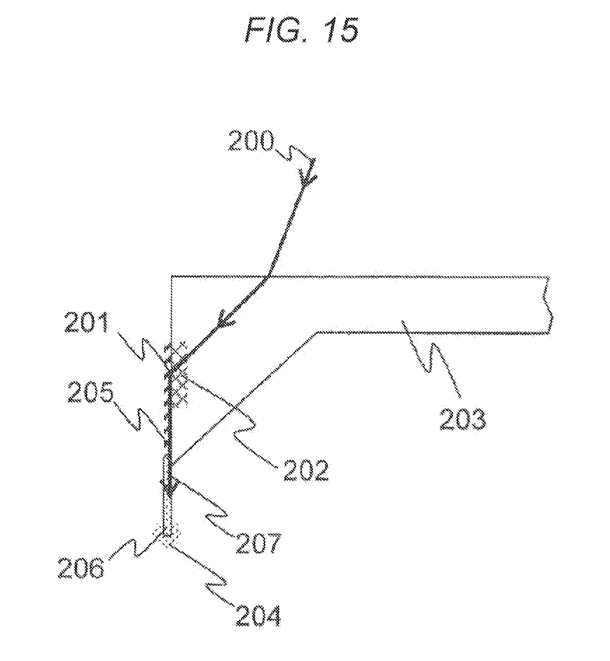

A second embodiment of the present invention will be described with reference to FIG. 15. The same components as those in the first embodiment are denoted by the same reference numerals and the description thereof will be omitted.

The present embodiment is characterized in that a cantilever 203 including an optical frequency (wavelength) conversion element 202 is provided instead of the cantilever 105 of the first embodiment.

Specifically, in the present embodiment, a prove will be described which has a structure that differentiates the optical frequencies (wavelengths) of the excitation light (incident light) and the measurement light (near-field light) by using a cantilever characterized to include a structure that converts the optical frequency (wavelength) of the incident excitation light immediately before exciting the plasmon, selectively acquires only the measurement light when detecting the measurement light generated from the near-field light, and enables a measurement in which background light and noise are suppressed.

FIG. 15 illustrates the cantilever 203 characterized to include the optical frequency (wavelength) conversion element 202 which is a component that converts the optical frequency (wavelength) of the incident excitation light 200 immediately before exciting the plasmon at the plasmon excitation point 201. Here, the optical frequency is a physical quantity according to the reciprocal of the wavelength of the excitation light 200.

As the optical frequency (wavelength) conversion element 202, for example, a nonlinear optical element or a light emitting element is used. As the nonlinear optical element, for example, a nonlinear optical crystal or a dye such as LBO, BBO, KTP, and KDP can be used. When using a material whose second degree term of the electric susceptibility X is not zero, it is possible to generate a higher harmonic wave such as a second harmonic wave, so that the nonlinear optical element is not limited the nonlinear optical crystals and the dyes described above.

When the above nonlinear optical crystals are used as the optical frequency (wavelength) conversion element 202 that converts the optical frequency, the optical frequency of the excitation light 200 can be an integral multiple thereof, so that the excitation light 200 and the near-field light 204 can be separated from each other by an optical frequency filter (also called a wavelength separation filter and a color filter because the light including different wavelengths are separated according to their wavelength). The near-field light 204 is generated at the top of a probe 206 by plasmon 207 excited at the excitation point 201.

When strong light with high directivity is used as the excitation light 200, not only the frequency of integral multiple of the frequency of the excitation light 200, but also sum frequency generation, difference frequency generation, and parametric oscillation can be used, so that the wavelength of the near-field light 204 can be a wavelength more suitable to detection.

When a nonlinear optical crystal is used as the optical frequency (wavelength) conversion element 202, for example, the cantilever 203 is fabricated by attaching the nonlinear optical crystal to the cantilever itself. When the crystal orientation of the nonlinear optical element does not form a predetermined angle with the polarization direction of the excitation light 200, the nonlinear optical element cannot satisfy a phase matching condition, so that a higher harmonic wave is not generated or the generation efficiency of the higher harmonic wave is significantly degraded. Therefore, the nonlinear optical element is required to be attached by considering the polarization direction of the excitation light 200. Alternatively, it is necessary to control the polarization of the excitation light 200 by considering the crystal orientation.

In a method in which the optical frequency (wavelength) conversion element 202 generates a higher harmonic wave, the wavelength of the near-field light 204 is shorter than that of the excitation light 200. Therefore, a metal film 205 that converts light into plasmon and the probe 206 that guides the plasmon 207 are required to be formed of a material suitable to the generated higher harmonic wave.

For example, near infrared light is used as the excitation light 200, the second harmonic is green (about 550 nm) or blue (about 450 nm), so that it is desirable to use silver as the metal film 205. The metal film 205 is determined by considering the refractive index at the converted wavelength and the refractive index of the probe.

When a light emitting element is used as a structure 202 that converts the optical frequency, the structure 202 that converts the optical frequency is formed by, for example, a dye, a fluorescent material, a semiconductor, a semiconductor microstructure, or a combination of these.

In the method that uses the light emitting element, light generated during radiative recombination after alleviating light excitation carriers by the excitation light 200 is used, so that the plasmon is excited by light whose frequency is lower than (whose wavelength is longer than) that of the excitation light 200.

When a light emitting element is used as the optical frequency (wavelength) conversion element 202, the cantilever 203 is fabricated by attaching a fluorescent material or a semiconductor to the cantilever itself. The light excitation of fluorescent material is often independent from direction and fluorescence of the fluorescent material is isotropically generated, so that there is an advantage that it is not necessary to particularly pay attention to the attaching method when attaching the fluorescent material. However, different from the case in which the nonlinear optical element is used, the light emission is isotropic regardless of the incident direction of the excitation light 200, so that the ratio of light contributing to generation of the plasmon in the converted light decreases as compared with a case in which the nonlinear optical element is used and the light emission that does not contribute to excitation of the plasmon may eventually be background noise.

When a semiconductor is used as a light emitting element, the same effects as those obtained when a fluorescent material is used are obtained. As the semiconductor, many composite semiconductors such as gallium arsenide (GaAs) and indium antimonide (InSb) can be used. To more efficiently generate light, a direct transition semiconductor may be selected. However, an emission wavelength is determined by a semiconductor, so that the selection of the semiconductor is required to be studied along with the selection of a material of a light guide unit and the probe.

When a semiconductor microstructure is used as a light emitting element, a light emission distribution is determined in a certain range by the incident direction of the excitation light 200 and the structure and it is possible to directionally generate light stronger than that generated when a fluorescent material is used or a semiconductor is used without structuring the semiconductor, so that it is expected that the excitation efficiency of the plasmon is improved.

However, it is necessary to set a fixing angle of the semiconductor microstructure to the cantilever 203 to an angle where the light emission from the semiconductor microstructure can efficiently excite the plasmon, so that the manufacturing is more difficult than when a fluorescent material is used or a semiconductor is used without structuring the semiconductor.

Examples of the semiconductor microstructure include a heterostructure and a double heterostructure of gallium arsenide (GaAs) and indium antimonide (InSb), a quantum well, and a superlattice. When a semiconductor microstructure is used, in addition to the direct transition semiconductor, silicon (Si) and germanium (Ge) can be used as an efficient light emitting element. This is because there is band folding in a superlattice of silicon, so that silicon that has originally been an indirect transition semiconductor behaves as a direct transition semiconductor in the entire microstructure.

The wavelength of emitted light and the wavelength where highly efficient excitation is possible are determined by the light emitting element, so that when selecting the light emitting element, it is necessary to carefully select the metal film 205 that excites the plasmon, the material of the cantilever 203, and the wavelength of the excitation light 200.

A method of forming the cantilever or the tip by an optical frequency (wavelength) conversion element may be employed.

As described above, according to the present embodiment, in addition to the effects obtained in the first embodiment, it is possible to selectively acquire only the measurement light when detecting the measurement light generated from the near-field light by differentiating the optical frequencies (wavelengths) of the excitation light (incident light) and the measurement light (near-field light), so that it is possible to perform a measurement in which background light and noise are suppressed. Thereby, it is possible to realize highly sensitive and highly accurate optical measurement of nanometer level.

### Third Embodiment

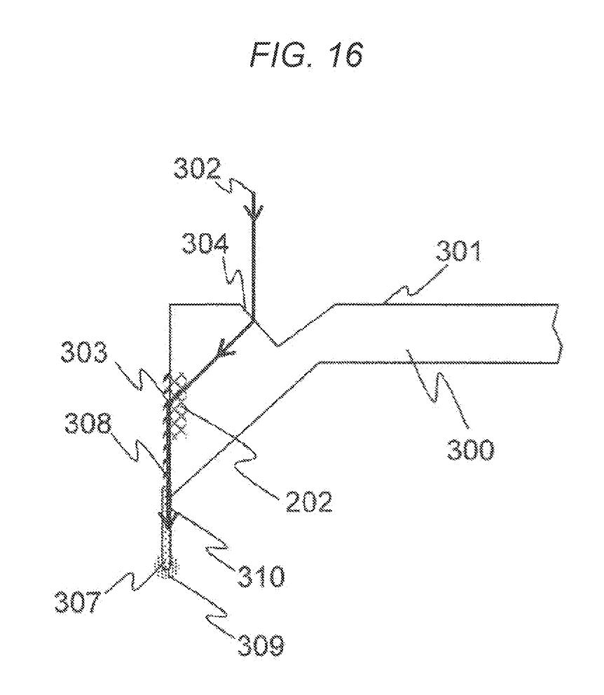

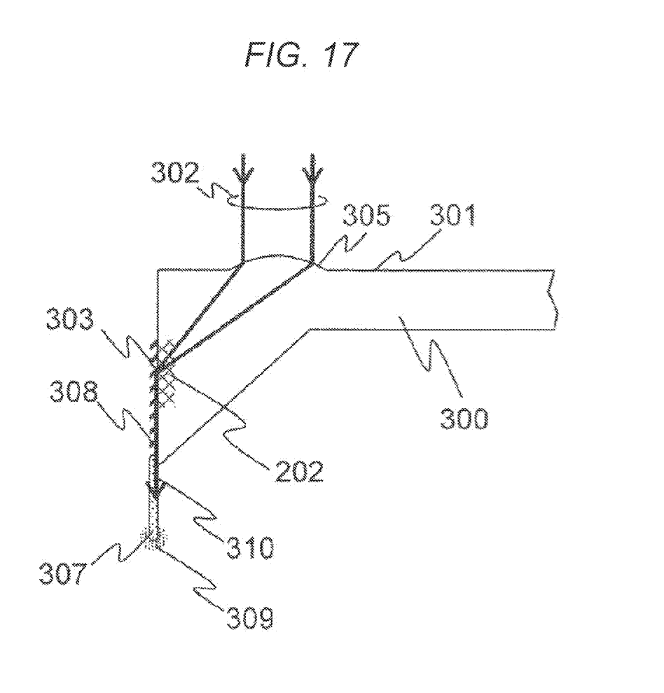

A third embodiment of the present invention will be described with reference to FIGS. 16 and 17. The same components as those in the first and the second embodiments are denoted by the same reference numerals and the description thereof will be omitted.

The present embodiment is characterized in that a cantilever 300 including a microstructure 304 or 305 that guides the irradiated excitation light to the excitation point at an optimal angle and an optical frequency (wavelength) conversion element 202 are provided instead of the cantilever 105 of the first embodiment or the cantilever 203 of the second embodiment.

Specifically, the present embodiment is about a highly efficient plasmon guiding and excitation system in which a cantilever including a microstructure for causing incident excitation light to enter a plasmon excitation point at a predetermined angle in order to excite the plasmon with high efficiency is combined with a probe including a microstructure that converts the optical frequency (wavelength) immediately before exciting the plasmon.

FIGS. 16 and 17 illustrate a structure example and a configuration example of the cantilever and the probe.

The cantilever 300 includes a microstructure 304 for refracting or diffracting excitation light 302 to a plasmon excitation point 303 on a rear surface 301 of the cantilever. Alternatively, the cantilever 300 includes a microstructure 305 for focusing the excitation light 302 to the plasmon excitation point 303. Immediately before the excitation light 302 is converted into plasmon on a surface or a ridge line of a tip provided at the top of the cantilever 300, the optical frequency (wavelength) conversion element 202 converts the optical frequency (wavelength) of the excitation light 302.

In the same manner as in the first embodiment, the microstructure 304 is a refractive surface provided by cutting the cantilever 300, a structure formed by newly depositing a material, a diffraction grating which is a periodic microstructure, and the like. The microstructure 305 is a curved refractive surface provided by cutting the cantilever or depositing a material, and the like. The optical frequency (wavelength) conversion element 202 is formed by a dye, a fluorescent material, a semiconductor, a semiconductor microstructure, or a combination of these.

The microstructure 304 can efficiently guide the excitation light 302 to the plasmon excitation point 303 by refracting or diffracting the excitation light 302, the optical frequency (wavelength) conversion element 202 converts the optical frequency (wavelength) of the guided excitation light 302, plasmon 310 is excited by using a metal film 308 and the like, and near-field light 309 is generated by guiding the plasmon 310 to the top of a probe 307. By this method, the near-field light 309 can be generated with high efficiency at the top of a probe 307 and the near-field light 309 can be selectively detected by differentiating the wavelengths of the excitation light 302 and the near-field light 309, so that it is possible to improve the SN ratio of the measurement.

It is possible to focus the excitation light 302 to the plasmon excitation point 303 by using the microstructure 305, so that, in addition to the above, the excitation efficiency of the plasmon can be further improved.

These methods have an advantage that the simplicity of adjustment of the excitation light 302 is improved or the reproducibility of the adjustment is improved because not only a measurement at a high SN ratio and a highly efficient measurement are possible but also a position which should be irradiated with the excitation light 302 on a cantilever rear surface 301 can be easily and clearly confirmed.

When a refractive surface is used as the microstructure 304, if the refractive index of the cantilever 300, the refractive index of a surrounding medium, and the angle of the excitation light entering the plasmon excitation point 303 are determined, the angle of the refractive surface is determined by Expression 3. When a nonlinear optical crystal is used as the optical frequency (wavelength) conversion element 202, if the propagation direction and the polarization of the excitation light 302 are determined, the crystal orientation of the nonlinear optical crystal is determined. Alternatively, the nonlinear optical crystal may be fixed at an angle where the nonlinear optical crystal can be easily mounted and then the polarization of the excitation light may be controlled. A method of fabricating the cantilever or the tip by the optical frequency (wavelength) conversion element may be employed.

When a diffraction grating is used as the microstructure 304, if the incident angle of the excitation light 302, the incident angle to the excitation point 303, the refractive index of the cantilever, the refractive index of a surrounding medium, and the wavelength of the excitation light are determined, the diffraction grating pitch is determined by Expression 5. Also in this case, the light optical (wavelength) conversion element 202 is mounted.

When a curved refractive surface is used as the microstructure 305, if the position where the refractive surface is provided and the incident angle to the excitation point 303 are determined, the curvature radius of the curve is determined, and if the incident angle of the excitation light 302, the incident angle to the excitation point 303, the refractive index of the cantilever, and the refractive index of a surrounding medium are determined, the angle of the refractive surface is determined. Also in this case, the optical frequency (wavelength) conversion element 202 is mounted in the same manner as described above.

As described above, according the present embodiment, the excitation efficiency of the plasmon can be improved and consequently the excitation efficiency of the near-field light can be improved, and further, it is possible to improve the signal to noise ratio (S/N) of the measurement result. Therefore, it is possible to realize more highly sensitive and highly accurate optical measurement of nanometer level.

Any of the embodiments that have been described merely represents a concrete example of implementation of the present invention and the technical scope of the present invention is not interpreted as being limited to these embodiments. In other words, the present invention can be implemented in various forms without departing from the technical idea or the main characteristics of the present invention. Further, the present invention may be implemented by combining the first to the third embodiments.

### REFERENCE SIGNS LIST

101 cantilever rear surface
102 excitation light
103 plasmon excitation point
104 refractive surface
105 microfabricated cantilever
106 focused ion beam
107 processed surface
108 substrate
109 cantilever material
110 minute shape structure
111 structure
112 diffractive surface
113 curved refractive surface
114 light beam center
115 surface
116 light source
117 probe
118 near-field light
119 sample
120 scattered light
121 near-field light detection sensor
200 excitation light
201 plasmon excitation point
202 optical frequency (wavelength) conversion element
203 cantilever
204 near-field light
205 metal film
206 probe
207 plasmon
300 cantilever
301 cantilever rear surface
302 excitation light
303 plasmon excitation point
304 microstructure
305 microstructure
307 probe
308 metal film
309 near-field light
310 plasmon

1-13. (canceled)

14. A scanning probe microscope, comprising:
a support member that supports a probe;
a light source that causes excitation light to enter the support member, and
a near-field light detection sensor that detects near-field light which is generated at a top of the probe by plasmon excited by the excitation light entering the support member and which is scattered from a surface of a measurement object,
wherein a microstructure that guides the excitation light to an excitation point of the plasmon is provided at a portion, which is irradiated with the excitation light, of the support member.

15. The scanning probe microscope according to claim 14, wherein the microstructure is a structure that refracts the excitation light.

16. The scanning probe microscope according to claim 14, wherein the microstructure is a structure that diffracts the excitation light.

17. The scanning probe microscope according to claim 14, wherein the microstructure is a structure that focuses the excitation light.

18. The scanning probe microscope according to claim 14, wherein the plasmon excited by the excitation light propagates through the support member and the probe and generates near-field light at a top of the probe.

19. The scanning probe microscope according to claim 14, wherein an optical frequency conversion element that converts an optical frequency of the excitation light is provided to the support member.

20. The scanning probe microscope according to claim 19, wherein the optical frequency conversion element is a light emitting element.

21. The scanning probe microscope according to claim 19, wherein the optical frequency conversion element is a nonlinear optical element.

22. The scanning probe microscope according to claim 19, wherein the plasmon excited by light whose optical frequency is converted by the optical frequency conversion element propagates through the support member and the probe and generates near-field light at a top of the probe.

23. The scanning probe microscope according to claim 14, wherein the microstructure is a structure that guides the excitation light to the excitation point of the plasmon at a predetermined angle.

24. The scanning probe microscope according to claim 14, wherein the microstructure is a cut surface, newly deposited material on the surface of the support member or a periodic microstructure.

25. A scanning probe microscope, comprising:
a support member that supports a probe;
a light source that causes excitation light to enter the support member, and
a near-field light detection sensor that detects near-field light which is generated at a top of the probe by plasmon excited by the excitation light entering the support member and which is scattered from a surface of a measurement object,
wherein an optical frequency conversion element that converts an optical frequency of the excitation light is provided to the support member.

26. The scanning probe microscope according to claim 25, wherein the optical frequency conversion element is a light emitting element.

27. The scanning probe microscope according to claim 25, wherein the optical frequency conversion element is a nonlinear optical element.

28. The scanning probe microscope according to claim 25, wherein the plasmon excited by light whose optical frequency is converted by the optical frequency conversion element propagates through the support member and the probe and generates near-field light at a top of the probe.

29. The scanning probe microscope according to claim 25, wherein the optical frequency conversion element guides the excitation light to the excitation point of the plasmon at a predetermined angle.

30. The scanning probe microscope according to claim 25, wherein the optical frequency conversion element is formed by a dye, a fluorescent material, a semiconductor microstructure or a combination of these.
